(19) United States
(12) Patent Application Publication
(10) Pub. No.: US 2007/0007282 A1
(43) Pub. Date: Jan. 11, 2007

(54) Method and plant for the thermal treatment of granular solids

(76) Inventors: Michael Stroder, Neu-Anspach (DE); Nikola Anastasijevic, Altenstadt (DE); Monika Willert-Porada, Bayreuth (DE); Thorsten Gerdes, Bayreuth (DE)

Correspondence Address: MORGAN & FINNEGAN, L.L.P., 3 WORLD FINANCIAL CENTER, NEW YORK, NY, 10281-2101, US

(21) Appl. No.: 10/540,072

(22) PCT Filed: Nov. 25, 2003
(86) PCT No.: PCT/EP03/13210

§ 371 Date: May 22, 2006

(30) Foreign Application Priority Data
Dec. 23, 2002 (DE) 10260744.3

(51) Int. Cl. H05B 6/64

(52) U.S. Cl. 219/686

(57) ABSTRACT

This invention relates to a method for the thermal treatment of granular solids in a reactor (1) with swirl chamber (4), which in particular constitutes an flash reactor or suspension reactor, wherein the microwave radiation from a microwave source (2) is fed into the reactor (1) through a wave guide, and to a corresponding plant. To avoid deposits in the wave guide, the same constitutes a gas supply tube (3), a gas stream being additionally fed through the gas supply tube (3) into the swirl chamber (4).

### TECHNICAL FIELD

This invention relates to a method for the thermal treatment of granular solids in a reactor with a swirl chamber, which in particular constitutes an flash reactor or suspension reactor, wherein microwave radiation is fed into the reactor through at least one wave guide, and to a corresponding plant. In this method, granular solids are thermally treated in a fluidized bed formed in the reactor, wherein fluidizing gas and electromagnetic waves (microwaves) coming from a microwave source are fed into the fluidized bed of the reactor, which constitutes a fluidized layer.

There are several possibilities for coupling a microwave source to such fluidized-bed reactors. These include for instance an open wave guide, a slot antenna, a coupling loop, a diaphragm, a coaxial antenna filled with gas or another dielectric, or a wave guide occluded with a microwave-transparent substance (window). The type of decoupling the microwaves from the feed conduit can be effected in different ways.

Theoretically, microwave energy can be transported in wave guides free of loss. The wave guide cross-section is obtained as a logical development of an electric oscillating circuit comprising coil and capacitor towards very high frequencies. Theoretically, such oscillating circuit can likewise be operated free of loss. In the case of a substantial increase of the resonance frequency, the coil of an electric oscillating circuit becomes half a winding, which corresponds to the one side of the wave guide cross-section. The capacitor becomes a plate capacitor, which likewise corresponds to two sides of the wave guide cross-section. In reality, an oscillating circuit loses energy due to the ohmic resistance in coil and capacitor. The wave guide loses energy due to the ohmic resistance in the wave guide wall.

Energy can be branched off from an electric oscillating circuit by coupling a second oscillating circuit thereto, which withdraws energy from the first one. Similarly, by flanging a second wave guide to a first wave guide energy can be decoupled from the same (wave guide transition). When the first wave guide is shut off behind the coupling point by a shorting plunger, the entire energy can even be diverted to the second wave guide.

The microwave energy in a wave guide is enclosed by the electrically conductive walls. In the walls, wall currents are flowing, and in the wave guide cross-section an electromagnetic field exists, whose field strength can be several 10 KV per meter. When an electrically conductive antenna rod is put into the wave guide, the same can directly dissipate the potential difference of the electromagnetic field and with a suitable shape also emit the same again at its end (antenna or probe decoupling). An antenna rod which enters the wave guide through an opening and contacts the wave guide wall at another point can still directly receive wall currents and likewise emit the same at its end. When the wave guide is shut off behind the antenna coupling by a shorting plunger, the entire energy can be diverted from the wave guide into the antenna in this case as well.

When the field lines of the wall currents in wave guides are interrupted by slots, microwave energy emerges from the wave guide through these slots (slot decoupling), as the energy cannot flow on in the wall. The wall currents in a rectangular wave guide flow parallel to the center line on the middle of the broad side of the wave guide, and transverse to the center line on the middle of the narrow side of the wave guide. Transverse slots in the broad side and longitudinal slots in the narrow side therefore decouple microwave radiation from wave guides.

Microwave radiation can be conducted in electrically conductive hollow sections of all kinds of geometries, as long as their dimensions do not fall below certain minimum values. The exact calculation of the resonance conditions involves rather complex mathematics, as the Maxwell equations (unsteady, nonlinear differential equations) must ultimately be solved with the corresponding marginal conditions. In the case of a rectangular or round wave guide cross-section, however, the equations can be simplified to such an extent that they can be solved analytically and problems as regards the design of wave guides become clearer and are easier to solve. Therefore, and due to the relatively easy production, only rectangular wave guides or round wave guides are used industrially, which are also preferably used in accordance with the invention. The chiefly used rectangular wave guides are standardized in the Anglo-Saxon literature. These standard dimensions were adopted in Germany, which is why odd dimensions appear in part. In general, all industrial microwave sources of the frequency 2.45 GHz are equipped with a rectangular wave guide of the type R26, which has a cross-section of 43×86 mm. In wave guides, different oscillation states exist: In the transversal electric mode (TE mode), the electric field component lies transverse to the wave guide direction and the magnetic component lies in wave guide direction. In the transversal magnetic mode (TM mode), the magnetic field component lies transverse to the wave guide direction and the electric component lies in wave guide direction. Both oscillation states can appear in all directions in space with different mode numbers (e.g. TE-1-1, TM-2-0).

A method for the thermal treatment of granular solids is known from U.S. Pat. No. 5,972,302, wherein sulfidic ore is subjected to an oxidation supported by microwaves. This method is chiefly concerned with the calcination of pyrite in a fluidized bed, wherein the microwaves introduced into the fluidized bed promote the formation of hematite and elementary sulfur and suppress the formation of SO₂. There is employed a stationary fluidized bed which is directly irradiated by the microwave source disposed directly above the same. The microwave source or the entrance point of the microwaves necessarily gets in contact with the gases, vapors and dusts ascending from the fluidized bed.

EP 0 403 820 81 describes a method for drying substances in a fluidized bed, wherein the microwave source is disposed outside the fluidized bed and the microwaves are introduced into the fluidized bed by means of a wave guide. There are frequently reflections of microwave radiation at the solids to be heated, whereby the efficiency is reduced and the microwave source is possibly damaged. In the case of open microwave wave guides, there are also dust deposits in the wave guide, which absorb part of the microwave radiation and can damage the microwave source.

### SUMMARY OF THE INVENTION

It is therefore the object underlying the invention to make the feeding of microwaves into a stationary or circulating fluidized bed more efficient and protect the microwave source against the resulting gases, vapors and dusts and the reflected microwave power.

In accordance with the invention, this object is substantially solved in a method as mentioned above in that the wave guide constitutes a gas supply tube and that in addition to the microwave radiation a gas stream is fed into the swirl chamber through the gas supply tube.

By means of the continuous gas stream from the wave guide it is reliably avoided that dust or process gases enter the wave guide, spread up to the microwave source and damage the same or form solid deposits in the wave guide. In accordance with the invention, microwave-transparent windows in the wave guide for shielding the microwave source, as they are commonly used in the prior art, can therefore be omitted. The same involve the problem that deposits of dust or other solids on the window can impair and partly absorb the microwave radiation. Therefore, the open wave guides in accordance with the invention are particularly advantageous. Thus, the microwave source can be arranged outside the circulating fluidized bed, the microwave radiation being fed into the fluidized-bed reactor through at least one open wave guide together with a gas stream.

It is also possible to introduce still dust-laden, hot process gas through the gas supply tube constituting a central tube or central gas tuyere into the reactor, with which process gas the solids in the swirl chamber are swirled. Since dust-laden gas would, however, reduce the efficiency of the microwave irradiation due to the absorption of microwave radiation by the dust particles, neutral, dust-free gas, e.g. purge gas, would first be passed through the gas supply tube in accordance with the invention, which neutral gas does not react with the substances contained in the reactor and hardly absorbs the microwave radiation. In continuation of this inventive idea, the dust-laden process gas is only introduced into the reactor space shortly before the entrance of the gas supply tube (central gas tuyere). During the thermal treatment in the circulating fluidized bed of the reactor, the solids circulate continuously between a fluidized-bed reactor (flash or suspension reactor), a solids separator connected with the upper region of the reactor, and a return conduit connecting the solids separator with the lower region of the fluidized-bed reactor. Usually, the amount of solids circulating per hour is at least three times the amount of solids present in the fluidized-bed reactor.

Another improvement is obtained when the gas stream introduced through the gas supply tube or the central gas tuyere is utilized for an additional fluidization of the reactor, i.e. part of the gas which so far has been introduced into the reactor through other supply conduits is used for dedusting the central gas tuyere constituting a wave guide. Providing neutral purge gas can thus be omitted, when the fluidizing gas used is not dust-laden or for other reasons absorbs an essential part of the introduced microwave power.

Another advantage is obtained in that by means of the continuous gas stream in the central gas tuyere constituting a wave guide solid deposits are avoided. These solid deposits change the cross-section of the wave guide in an undesired way and absorb part of the microwave energy which was designed for the solids in the reactor. Due to the absorption of energy in the central gas tuyere, the same would also heat up very much, whereby the material would be subject to a strong thermal wear. In addition, solid deposits in the central gas tuyere would effect undesired feedback reactions to the microwave source.

Suitable microwave sources, i.e. sources for the electromagnetic waves, include e.g. a magnetron or klystron. Furthermore, high-frequency generators with corresponding coils or power transistors can be used. The frequencies of the electromagnetic waves proceeding from the microwave source usually lie in the range from 300 MHz to 30 GHz. Preferably, the ISM frequencies 435 MHz, 915 MHz and 2.45 GHz are used. Expediently, the optimum frequencies are determined for each application in a trial operation.

In accordance with the invention, the gas supply tube which also serves as wave guide wholly or largely consists of electrically conductive material, e.g. copper. The length of the wave guide lies in the range from 0.1 to 10 m. The wave guide may be straight or curved. There are preferably used sections of round or rectangular cross-section, the dimensions being adjusted in particular to the frequency used.

In accordance with the invention, the gas velocities in the wave guide (gas supply tube) are adjusted such that the Particle-Froude-Numbers in the wave guide lie in the range between 0.1 and 100. The Particle-Froude-Numbers are defined as follows:

$${Fr}_{P} = \frac{u}{\sqrt{\frac{( {ρ}_{s} - {ρ}_{f} )}{{ρ}_{f}} * {d}_{p} * g}}$$

with

u=effective velocity of the gas flow in m/s

ρₛ=density of the solid particles or process gases entering the wave guide in kg/m³

ρ_{f}=effective density of the purge gas in the wave guide in kg/m³

dₚ=mean diameter in m of the particles of the reactor inventory (or the particles formed) during operation of the reactor

g=gravitational constant in m/s².

To prevent solid particles or generated process gases from the reactor from penetrating into the wave guide, gas serving as purge gas for instance flows through the wave guide. Solid particles can for instance be dust particles present in the reactor or also the treated solids. Process gases are generated in the processes which take place in the reactor. By specifying certain Particle-Froude-Numbers, the density ratio of the entering solid particles or process gases to the purge gas is considered in accordance with the invention when adjusting the gas velocities, which ratio, apart from the velocity of the gas stream, is decisive for the question whether or not the gas stream can entrain the entering particles. Substances can thereby be prevented from penetrating into the wave guide. It turned out that with the aforementioned Particle-Froude-Numbers in the wave guide good process conditions exist in the reactor for the solids to be treated. For most applications, a Particle-Froude-Number between 2 and 30 is preferred in the wave guide.

The temperatures in the fluidized bed lie for instance in the range from 150 to 1200° C., and it may be recommended to introduce additional heat into the fluidized bed, e.g. through indirect heat exchange. For temperature measurement in the fluidized bed, insulated sensing elements, radiation pyrometers or fiber-optic sensors can be used.

The granular solids to be treated by the method in accordance with the invention can for instance be ores and in particular sulfidic ores, which are prepared e.g. for recovering gold, copper or zinc. Furthermore, recycling substances, e.g. zinc-containing processing oxide or waste substances, can be subjected to the thermal treatment in the fluidized bed. If sulfidic ores, such as e.g. auriferous arsenopyrite, are subjected to the method, the sulfide is converted to oxide, and with a suitable procedure there is preferably formed elementary sulfur and only small amounts of SO₂. The method of the invention loosens the structure of the ore in a favorable way, so that the subsequent gold leaching leads to improved yields. The arsenic iron sulfide (FeAsS) preferably formed by the thermal treatment can easily be disposed of. Expediently, the solids to be treated at least partly absorb the electromagnetic radiation used and thus heat the bed. It was surprisingly found out that in particular material treated at high field strengths can be leached more easily. Frequently, other technical advantages can be realized as well, such as reduced retention times or a decrease of the required process temperatures.

The present invention furthermore relates to a plant in particular for performing the above-described method for the thermal treatment of granular solids. A plant in accordance with the invention includes a reactor with swirl chamber, which in particular constitutes an flash or suspension reactor, a microwave source disposed outside the reactor, and a wave guide for feeding the microwave radiation into the reactor, wherein the wave guide constitutes a gas supply tube through which a gas stream can be fed into the swirl chamber in addition to the microwave radiation. The gas stream serves to generate a circulating fluidized bed in the swirl chamber of the reactor.

Developments, advantages and possible applications of the present invention can also be taken from the following description of an example and from the drawing. All described and/or illustrated features per se or in any combination belong to the subject-matter of the invention, independent of their inclusion in the claims or their back-reference.

### BRIEF DESCRIPTION OF THE DRAWING

In the drawing

FIG. 1 shows a schematic representation of an flash reactor with microwave coupling in accordance with the invention.

### DETAILED DESCRIPTION OF THE PREFERRED EMBODIMENT

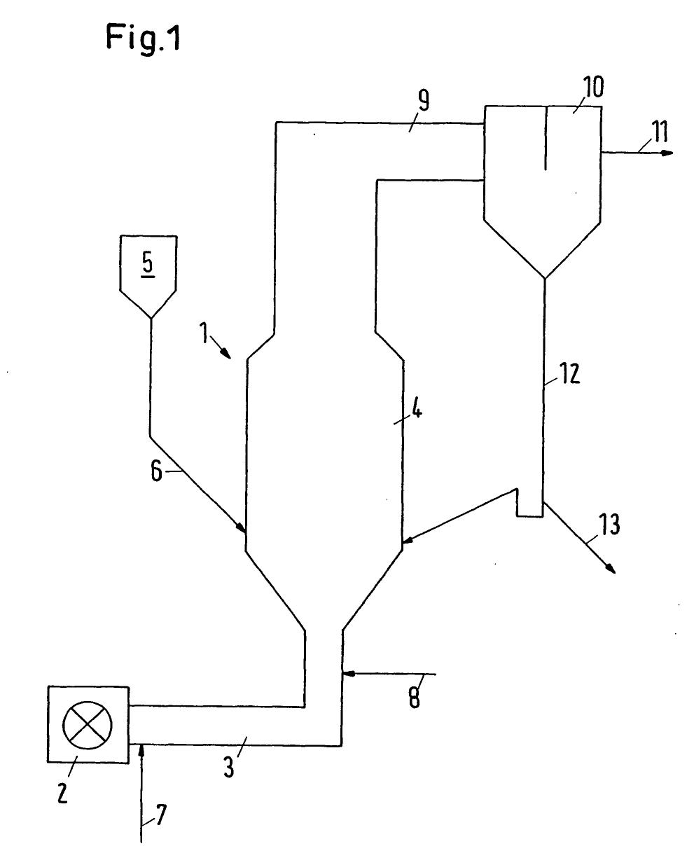

FIG. 1 shows a plant for performing the method in accordance with the invention for the thermal treatment of granular solids in a circulating fluidized bed.

The plant includes a reactor 1 constituting an flash reactor, into which granular solids to be treated are introduced from a solid bunker 5 through a supply conduit 6. The solids get into the swirl chamber 4 of the reactor 1 and are entrained by a gas stream introduced through the gas supply tube 3, so that they form a circulating fluidized bed in the swirl chamber 4. For this purpose, the gas supply tube can constitute in particular a central gas tuyere. To supply the necessary heat to the process taking place in the reactor 1, a microwave source 2 acting as combustion chamber is provided upstream of the reactor, from which microwave source microwave rays are introduced into the reactor space (swirl chamber 4) via the gas supply tube 3 constituting a wave guide. The solids in the reactor 1 absorb the introduced microwave radiation and are thereby heated to the desired process temperature.

At the same time, purge gas is introduced via a conduit 7 through the gas supply tube 3 (central gas tuyere) into the swirl chamber 4, where it swirls the solids. The Particle-Froude-Number Frₚ in the gas supply tube 3 is about 25. In the swirl chamber 4, the Particle-Froude-Number Frₚ is about 6, and in dependence on the respective process deviations may be obtained. The purge gas, for instance fluidizing air, can also be preheated for technical reasons. Via a feed conduit 8, further gas, e.g. dust-laden hot process gas, can optionally be introduced into the gas supply tube. This supply of further process gas is effected shortly before the gas supply tube 3 opening into the swirl chamber 4, so that the microwave radiation rather unimpededly impinges on the solids and is not absorbed by dust in the process gas. Thereby, a high efficiency of the microwave irradiation is achieved.

In the swirl chamber 4, the desired reaction of the solids with the process gas then takes place. The gas containing the solids subsequently flows into the upper part of the reactor 1, from where it flows together with the entrained solids via an outlet 9 into the separator 10, at the front side of which the gas is withdrawn via conduit 11. The separated solids are recirculated from the bottom of the separator 10 via a return conduit 12 into the swirl chamber 4 of the reactor 1, and it is also possible to withdraw part of the fine-grained solids via a discharge conduit 13.

To make the feeding of microwaves into a reactor 1 with circulating fluidized bed, in particular an flash reactor, more efficient and also protect the microwave source 2 against gases, vapors, dusts and reflected microwave rays, the microwave source in accordance with the invention is disposed outside the reactor 1. The microwave radiation is fed into the swirl chamber of the reactor 1 through at least one open wave guide, the wave guide constituting a gas supply tube 3 through which a gas stream in addition to the microwave radiation is fed into the reactor 1 for generating a circulating fluidized bed.

### EXAMPLE

### Calcination of Magnesite

The following Table indicates typical method parameters for a calcination of magnesite. For comparison, the data are indicated with and without the irradiation of microwaves in accordance with the invention. The frequency of the irradiated microwaves is 2.45 GHz. The entire fluidizing air is supplied via conduit 7. In this example, further process gas is not admixed through conduit 8.

Feed Magnesite

| | | | Microwave- |
|---|---|---|---|
| | Units | Conventionally | supported |
| Type of reactor | | Flash reactor | Flash reactor + |
| | | | microwaves |
| Mode of operation | | continuously | continuously |
| Flow rate | kg/h | 252 | 245 |
| Grain size | 100% | <0.20 mm | <0.20 mm |
| Fluidizing air, furnace | Nm³/h | 300 | 300 |
| inlet | | | |
| Temperature | ° C. | 750 | 720 |
| Energy input | | | |
| Fuel oil | l/h | 28.5 | 26.5 |
| Microwave | kW | 0 | 6 |
| Product quality | | | |
| Annealing loss | % | 2.3 | 0.4 |

The product quality can be improved substantially by the proposed method.

### LIST OF REFERENCE NUMERALS

1 reactor
2 microwave source
3 gas supply tube, central gas tuyere, wave guide
4 swirl chamber
5 solid bunker
6 supply conduit
7 conduit
8 feed conduit
9 outlet
10 separator
11 conduit
12 return conduit
13 discharge conduit

1. A method for thermal treating granular solids in a reactor with a swirl chamber, feeding microwave radiation from a microwave source into the reactor through a wave guide, wherein the wave guide constitutes a gas supply tube and additionally feeding a gas stream through the gas supply tube into the swirl chamber.

2. The method as claimed in claim 1, wherein the gas stream introduced through the gas supply tube is utilized for an additional fluidization of a fluidized bed formed in the swirl chamber.

3. The method as claimed in claim 1, wherein by introducing the gas stream into the gas supply tube, solid deposits in the gas supply tube are avoided.

4. The method as claimed in claim 1, wherein the microwave radiation has a frequency between 300 MHz and 30 GHz.

5. The method as claimed in claim 1, wherein the reactor has a temperature between 150° C. and 1200° C.

6. A plant for thermal treating granular solids, as claimed in claim 1, comprising a reactor with swirl chamber, a microwave source disposed outside the reactor, and a wave guide for feeding microwave radiation into the reactor, wherein the wave guide constitutes a gas supply tube through which a gas stream can additionally be fed into the swirl chamber.

7. The plant as claimed in claim 6, wherein the gas supply tube has a rectangular or round cross-section which is adjustable to the used frequency of the microwave radiation.

8. The plant as claimed in claim 6, wherein the gas supply tube has a length of 0.1 m to 10 m.

9. The method as claimed in claim 4, wherein the frequency is 435 MHz, 915 MHz, or 2.45 GHz.

10. The method as claimed in claim 6, wherein the swirl chamber comprises a flash reactor or a suspension reactor.
